(19) United States
(12) Patent Application Publication
(10) Pub. No.: US 2002/0117428 A1
(43) Pub. Date: Aug. 29, 2002

(54) Mechanism for granular separation

(75) Inventor: Dennis Rapaport, Ramat Hasharon (IL)

Correspondence Address: Paul D. Greeley, Esq., Ohlandt, Greeley, Ruggiero & Perle. L.L.P., 10th Floor, One Landmark Square, Stamford, CT, 06901-2682, US

(73) Assignee: BAR-ILAN UNIVERSITY

(21) Appl. No.: 10/038,092

(22) Filed: Jan. 3, 2002

(30) Foreign Application Priority Data
Jan. 8, 2001 (IL) 140799

(51) Int. Cl. B07B 13/11; B03B 5/06

(52) U.S. Cl. 209/481; 209/695; 209/691; 209/485

(57) ABSTRACT

Method and apparatus for separating granules of different sizes from a granular mixture, by combination of vertical size separation under vibration and horizontal flow. A horizontal base plate with an asymmetric saw-tooth upper profile is provided and a mixture of granules is fed onto the base plate. The base plate is then vertically vibrated, so as to separate the mixture into superimposed, partial layers of granules of different sizes, while horizontally advancing the same in opposite directions and separately collecting these layers.

### FIELD OF THE INVENTION

The present invention relates to the field of granular separation. Specifically, the invention describes a method and an apparatus for separating granules of at least two different sizes comprised in a granular material.

### BACKGROUND OF THE INVENTION

Granular materials are very important from the industrial and technological point of view. Among the many granular materials involved are pills, seeds, gravel, sand, coal, grains, etc. that are involved in industrial processes in industries including pharmaceuticals, agriculture, mining, dry food processing, etc.

In the prior art much effort and resources have been devoted to the problem of separating granular particles (the terms “granules”, “particles” and “granular particles” will be used herein as synonymous) by size, weight, or other characteristics.

Many techniques have been developed for the dry separation of granular particles of different sizes from a mixture. One technique consists in causing the mixture to move in a direction perpendicular to a flow of gas which blows the lighter particles to one side, while the heavier particles continue in approximately their original trajectory. This results in a spatial separation of the particles according to weight or size if the particles have similar densities.

Other methods are based on the principle of filtration. The mixture is passed over a screen, or series of screens with various size openings. Particles larger than the openings remain on the screen, while the smaller ones fall through.

In industrial practice, combination of these techniques involving filtration and air flows are commonly combined. In addition, vibration, both vertical and horizontal, is often applied to aid in the separation process, especially when using screens to separate granular mixtures.

The great number of patents describing almost every conceivable variation and combination of these techniques is testimony to the importance of the problem of granular separation in industry. New improvements are constantly being proposed and the latest technology including electro-optical scanning techniques are incorporated into the more recently developed sorting systems.

It is an objective of this invention to provide a method of separation of granular materials of different sizes that is based on a physical principle different from that of any of the existing methods.

It is another object to provide an apparatus for carrying out said separation.

It is a further object to provide such a method and apparatus that avoid or minimize damage to the material treated.

It is a still further object to provide such a method and apparatus that are not subject to clogging.

It is a still further object to provide such a method and apparatus that can operate in a vacuum.

Other objects and advantages of the invention will appear as the description proceeds.

### SUMMARY OF THE INVENTION

The present invention provides a method for separating granules of different sizes from a mixture, based on a combination of vertical size separation under vibration and horizontal flow. The method of the invention comprises the following steps:

a) providing a horizontal base plate with an asymmetric sawtooth upper profile;

b) feeding a mixture of granules onto said base plate;

c) vertically vibrating said base plate, whereby to separate the mixture into superimposed, partial layers of granules of different sizes, which spontaneously move horizontally in different directions and at different rates; and

d) separately collecting the said layers.

The terms “vertical” and “horizontal” should not be construed strictly. In particular, the base plate may be moderately slanted with respect to the horizontal, its vibration may deviate moderately from a vertical direction, and the superimposed layers may be advanced at a moderate angle to the horizontal.

By “size” is meant here the volume of the granules. The method of the invention separates at least two different sizes of granules, and may separate more.

The method is based on a novel combination of two distinct physical phenomena. The first phenomenon is observed when a layer of granular particles, consisting of grains of different sizes, is placed on a flat horizontal base plate and the plate is caused to vibrate in the vertical direction. The well-known result of this operation (Rosato, et.al., Phys. Rev. Lett. 58, 1038 (1987)) is that the larger grains tend to rise to the top of the layer, whereby two, or more, superimposed partial layers are formed.

The second phenomenon is observed if the flat plate is replaced with a base having an asymmetric sawtooth profile and all grains are of similar size: the granular material will flow horizontally in a direction perpendicular to the sawteeth. Experiment and simulation display the complex dependence of the flow direction and magnitude on the parameters defining the system. (Z. Farkas, et. al., Phys. Rev. E 60, 7022 (1999).

In said second phenomenon, the flow direction and magnitude depend on many parameters (sawtooth shape, frequency and amplitude of vibration, mechanical properties of the grains, etc.) that define the system in a complex manner; and the flow rate varies with the height of the superimposed, partial layers (M. Levanon and D. C. Rapaport, article submitted for publication). Surprisingly, oppositely directed flows can occur simultaneously at different levels. Considering the strongly stratified nature of the flow, the sensitive parameter dependence of the overall flow of the granular mass is readily understood as being a consequence of competition between opposing flows.

It will be apparent to the skilled person that the method of this invention provides a new and important industrial solution to the problem of sorting granular matter according to size.

The separation of granules of different sizes into distinct superimposed layers may not be complete. Some larger granules may be mixed with the collected smaller granules and vice versa. In this case, the collected layers may undergo an additional separation by the method of the invention or by any other convenient method.

Assuming the granules to have all the same density, the method of the invention is applicable to mixtures the granules of which have sizes not too small that dispersion fails to occur under vibration, and not too large otherwise particles will be damaged, typically having granule diameters from 0.01 to 10 mm. The frequency of the vibrations of the base plate is similar to that used in vibration separation machinery.

The invention also comprises an apparatus for granular separation, which comprises:

a) a base plate having a sawtooth upper profile;

b) a vibrator or vibrators for causing said plate to vibrate vertically;

c) a feeder, or feed mechanism, for feeding the granular mixture to be separated onto said base plate, so as to form a layer thereon; and

d) means for separately collecting the oppositely flowing, superimposed partial layers of granules produced by the vibration of said base plate.

The vibrators may be of any known kind, such as purely mechanical or pneumatic, or electro-mechanical. The feeder, while essentially conventional, should be such as to cause the formation of an even layer of granular mixture on the base plate. Since the granules advance horizontally, said feeder should be placed at or near the middle of the base plate and should feed the mixture at a rate matching the rate at which the granules advance horizontally. A preferred feeder will be described hereinafter. The means for separately collecting the superimposed layers may comprise horizontal or sub-horizontal separating plates, or moving belts, and corresponding collecting vessels at opposite ends of the apparatus.

Optionally, the apparatus may comprise means for controlling the vibration amplitude and frequency and/or a general control for synchronizing all movable parts of the apparatus.

The apparatus of the invention has been described so far as having a linear configuration, viz. comprising an essentially rectangular base plate, one dimension of which, generally the larger one, is parallel to the direction of flow of the granules. However, in a different embodiment of the invention, the apparatus may have a cylindrical configuration, the base plate being essentially circular and the sawteeth being concentric rings, the flow of the granules being to the center and to the periphery. Granules would be collected through an aperture at the center, and at the periphery.

In the present description it is assumed that the base plate is horizontal. In some cases, it might be desirable to slant it moderately to enhance the separation rate. Other configurations based on the same principle are also possible.

Optionally, the sawtooth profile may be changed to improve efficiency. Also optionally, an injected vertical air flow may enhance fluidization.

### BRIEF DESCRIPTION OF THE DRAWINGS

FIG. 1 is a schematic diagram of the sawtooth base plate used in an embodiment of the invention;

FIG. 2 is a schematic longitudinal cross-section of an apparatus according to an embodiment of the invention;

FIGS. 3A-3E are computer screen images showing stages in the size separation process according to an embodiment of the invention;

FIG. 4 shows the time-varying concentration profile for large and small particles in an embodiment where grains are confined by fixed walls at the ends of the vibrating plate;

FIG. 5 shows the position of the center of mass of the large particles as a function of time in an embodiment where grains are confined by fixed walls at the ends of the vibrating plate;

FIG. 6 shows the stratified flow velocity as a function of height where grains are of a single size only; and

FIG. 7 shows a late stage of separation in a three-dimensional cylindrical system.

### DETAILED DESCRIPTION OF PREFERRED EMBODIMENT

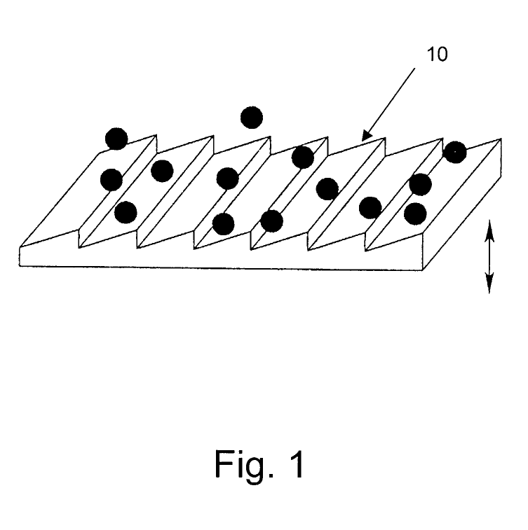

FIG. 1 is a schematic isometric presentation of a base plate 10 having an isometric sawtooth upper surface. A few particles are shown in the sketch, and schematically represent the whole granular mass that is to undergo the separation. The granules which constitute the separate, partial layers, not illustrated in the drawings, will, in addition to their vertical vibration, flow in a horizontal direction perpendicular to the sawteeth. The arrows in the drawing indicates the vertical vibration of the base plate.

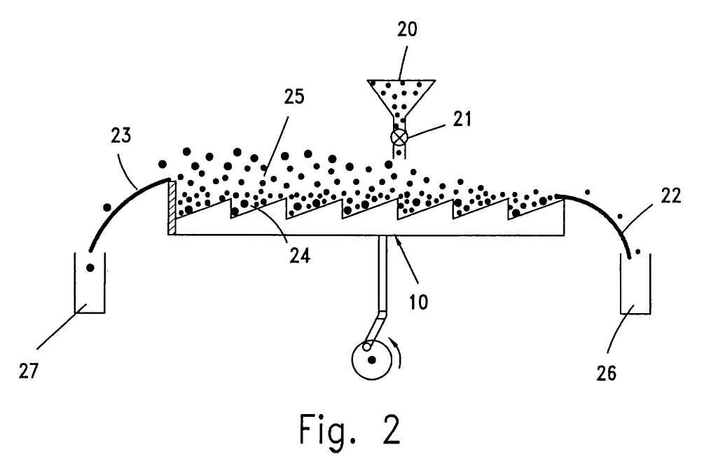

FIG. 2 is a longitudinal cross-section of a base plate 10. The base plate could be made of elemental sections connected together, but this variant, which is very easily carried out by the skilled person, is not shown in the drawing. A vibrator 11 is schematically shown at the center of the base plate 10, schematically indicated as consisting of a mechanically reciprocating rod which vibrates vertically. The plate 10 is also confined to move only in the vertical direction. Other vibration producing mechanisms can also be used, which would provide greater flexibility in choosing the properties—frequency, amplitude, acceleration at different points in the cycle of the vibration.

FIG. 1 can be understood and studied by considering a longitudinal cross-section such as shown in FIG. 2, or a narrow strip parallel to that cross-section. Configuration of such a strip will give a full picture of the operation of the apparatus as long as the lateral boundaries, e.g. vertical plates, which the apparatus will inevitably comprise, do not have a significant influence on the motion of the particles. This will occur if the width of the base plate is sufficiently large and the lateral vertical plates are sufficiently smooth.

In the example of FIG. 2, it is shown how superimposed, partial layers of granules are separately collected. The granular mass to be separated is fed onto the base plate 10, as schematically shown in this drawing, by a feed mechanism, which comprises a hopper 20 and discharge valve 21, which can be controlled to regulate the rate at which the granular material is fed onto the base plate 10. Material can be fed into hopper 20 in any desired way. At opposite ends of plate 10, are two plates, 22 and 23, which receive the lower layer 24 of smaller granules and the upper layer 25 of larger granules, respectively. 24 is collected in a bin 26 and for layer 25 in a bin 27. In place of plates 22 and 23 one could use belts, these not being shown in the drawing.

In all this description, it is assumed that all the granules have the same density. This will generally be the case, since the separation is carried out only according to volume. If granules of different densities were included in the feed mixture, a separation according to the invention might be less perfect.

The following considerations, involving computer simulation of granular flow, will permit better to understand the phenomena on which the invention is based and these can be followed in carrying the invention into practice.

Granular dynamics simulation provides the methodology for detailed microscopic modeling on the granular scale. The description of the behavior of a granular system is to be found in the structure and motion of its constituent building blocks, and the dynamics is contained in the solution to the N-body problem. Given that the classical N-body problem lacks a general analytical solution, the only path open is the numerical one. A comprehensive discussion of the methodology involved in the computer simulations described below can be found in D. C. Rapaport, The Art of Molecular Dynamics Simulation (Cambridge University Press, Cambridge, 1995).

Although the real system is a three dimensional one, the large number of particles and complexity of the interactions between them result in an extremely large number of computations. Therefore, it is common practice, in studying such systems without losing any of the essential physics, to perform the calculations in two dimensions for simplicity. The results of many other similar studies with granular systems have revealed good correlation between the results of calculations based on two-dimensional models and experimentally measured behavior of actual three-dimensional systems. Three-dimensional modeling will also be considered at the end of the Examples below.

In said Examples, the distribution of particles is taken as bimodal, with values randomly distributed over narrow ranges extending from the nominal small and large sizes to values 10% below the nominal ones. For convenience, reduced units are used in which length is expressed in terms of the nominal diameter of the smallest particles, which is given the length of one. Particles with unit diameter, i.e. the nominally small particles, have unit mass and a suitable unit of time is also defined.

The use of reduced units in describing the particles (as well as the base of the system as will be described below) implies that any size particles can be used in the calculations. In actuality, the range of sizes for which the results of the calculation can be expected to agree with experimental results is limited by the validity of the model used to describe the interactions between the particles and with the base of the system. For example, for very fine powders electrostatic forces are important. These forces are not taken into account in the model used in the following Examples. Because of this, the smallest particles for which such methods are applicable are assumed to be of a size in the order of magnitude of granules of fine sand, for example 0.05 mm. Because of the assumptions made about the elasticity of the particles, the largest particles are typically of a size in the order of gravel, for example 1 cm. The ratio between the nominal diameters of the large and small particles is not restricted by the assumptions of the model chosen.

The model for the grains used herein is based on inelastically colliding soft particles. The model is based on the well-known Lennard-Jones potential; which describes the behavior, on collision, of stiff elastic spheres. The model takes into account small distortions and elastic forces and describes a repulsive force that becomes increasingly strong as the particles come into contact and drops rapidly to zero as the particles move apart. This and similar models and also the computational techniques employed here are useful and widely used for granular simulation work (see, for example, the above referenced book and D. Hirshfeld and D. C. Rapaport, Phys. Rev. E 56, 2012 (1997)).

The interaction that prevents overlap when grains collide is assumed to have the Lennard-Jones form with a cutoff at the point where the repulsive force falls to zero. For grains located at rᵢ and rⱼ this force is:

$${f}_{i j}^{r} = \frac{48 ε}{{r}_{i j}} [ {( \frac{{σ}_{i j}}{{r}_{i j}} )}^{12} - \frac{1}{2} {( \frac{{σ}_{i j}}{{r}_{i j}} )}^{6} ] {\hat{r}}_{i j}$$

for rᵢⱼ<2^{⅙}σᵢⱼ and zero otherwise.

Here rᵢⱼ=|rᵢⱼ|=|rᵢ−rⱼ| and σᵢⱼ=(σᵢ+σⱼ)/2. σᵢ is the approximate diameter of particle i, although since the particles are slightly soft, this is not precisely defined.

Two damping forces act during the collision. The normal damping force acting during the collision is

f ᵢⱼⁿ=−γₙ(\dot{r}ᵢⱼ·\hat{r}ᵢⱼ)\hat{r}ᵢⱼ

The transverse damping force is

f ᵢⱼ=−min(μ|f ᵢⱼ^{r}+fᵢⱼⁿ|,γₛ|νᵢⱼ^{s}|)\hat{ν}ᵢⱼ^{s}

where νᵢⱼ^{s} is the relative tangential velocity of the particle (which depends on their angular velocities and the relative translational velocity).

In the following description, the value of the static friction coefficient used is μ=0.5, the normal and transverse damping coefficients are γₙ=γₛ=5.

The sawtooth base plate may conveniently be constructed from a set of grain-like particles positioned to produce the required profile; these particles oscillate vertically in unison to produce the effect of a sinusoidally vibrated base plate. The particles themselves interact with the grains according to the same particles forces described above.

Two different approaches can be considered for describing the horizontal boundaries of the system. In the first, the system is horizontally periodic. In the second, the system is bounded horizontally by reflecting walls.

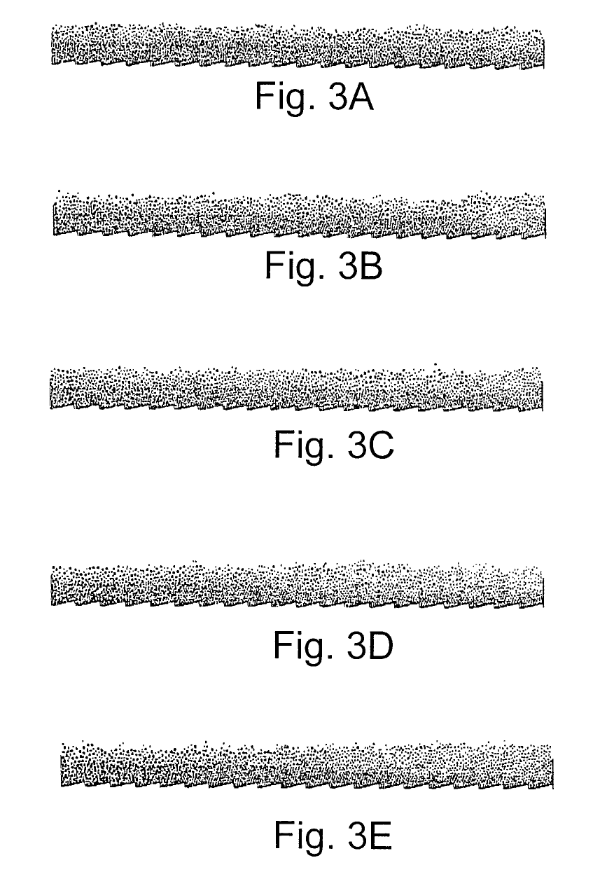

FIGS. 3A to 3E are a set of low resolution computer screen images for a mixture in which there is a 15% concentration of the larger particles (shown more darkly shaded) with a diameter 1.4 times that of the rest. FIG. 3A shows the initial state of the system with the large particles randomly distributed throughout the layer. Subsequent figures show the way the particles are distributed after 1000, 2000, 4000, and 16000 vibration cycles; the onset of segregation—marked by the leftward motion of the large particles—is clearly visible.

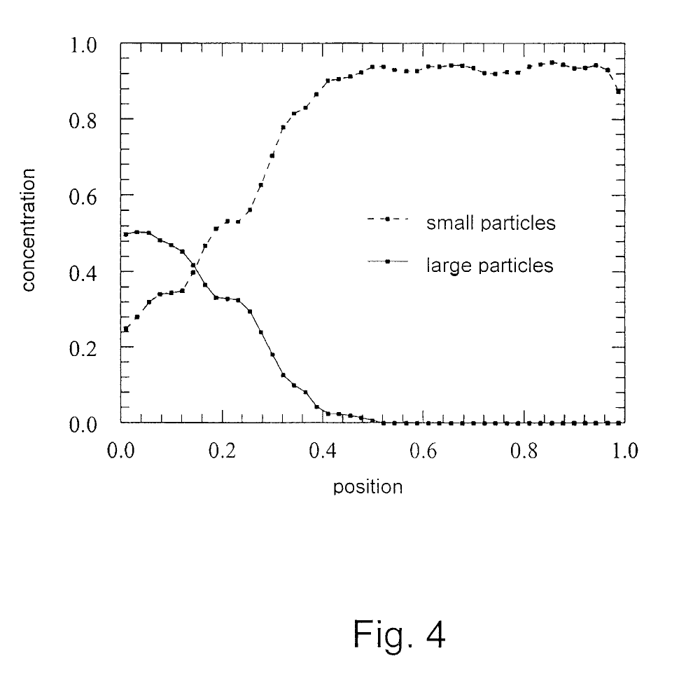

The concentration profiles after 8100 cycles for the large (solid lines) and small particles are shown in FIG. 4. The system width (in reduced units) is 180 and the nominal number of layers is 8. The values of frequency (f), amplitude (A), and gravitational acceleration (g) are 0.4, 1, and 5 respectively (the corresponding dimensionless acceleration Γ=(2Πf)²A/g=1.26, where Γ=1 is close to the minimum required to excite the layer). The large particle diameter and concentration are 1.2 and 15%. The base contains 20 sawteeth of height 2, with an asymmetry such that the right edge of each tooth is practically vertical. Results are averaged over short times and smoothed to reduce measurement fluctuations. The effectiveness of the separation process is apparent, starting from an initially uniform system, and ending with the large particles having gradually migrated to the left (position 0 in FIG. 4) side of the container and the majority of the small particles to the right.

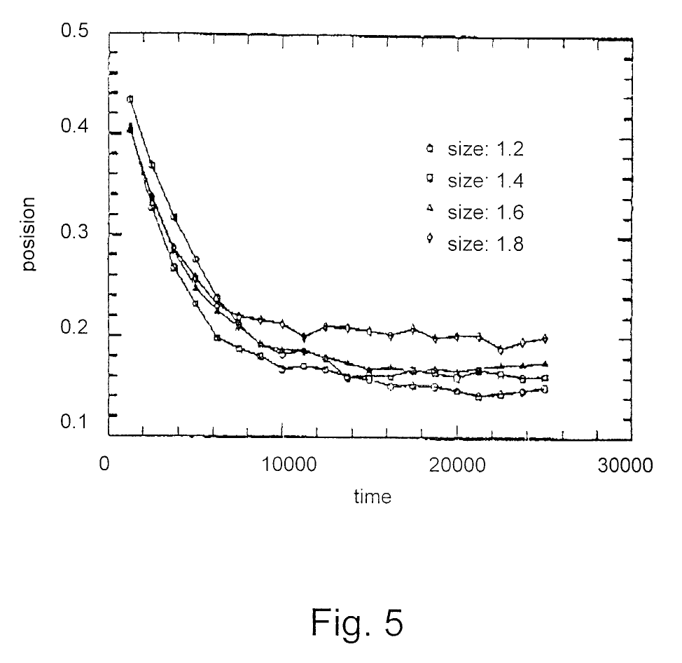

The dependence of the separation rate on the size of the particles is shown in FIG. 5. It is measured in terms of the position of the center of mass of all the large particles as a function of time (any large particles that become trapped in wells between the teeth before migration is complete will adversely affect this measurement). In FIG. 5, the position of the center of mass is measured from the left (FIG. 1) to right. The separation rates are seen to differ, but the overall behavior in all cases is very similar.

The units used in simulation can be converted to physical units. Assuming a typical granule diameter of 1 mm, this defines the unit of length. Since g=5 here (in MKS units it is 9.8 m/sec²), the simulational time unit is 0.022 sec. The vibration frequency f=0.4, then corresponds to ≈20 Hz. A horizontal flow speed of 0.2 is equivalent to ≈10⁻² m/sec.

The stratified flows in the case of monodisperse granular particles were observed to depend, often in a complex manner, on the many parameters that define the system. A similar dependence occurs for the granular mixtures considered here.

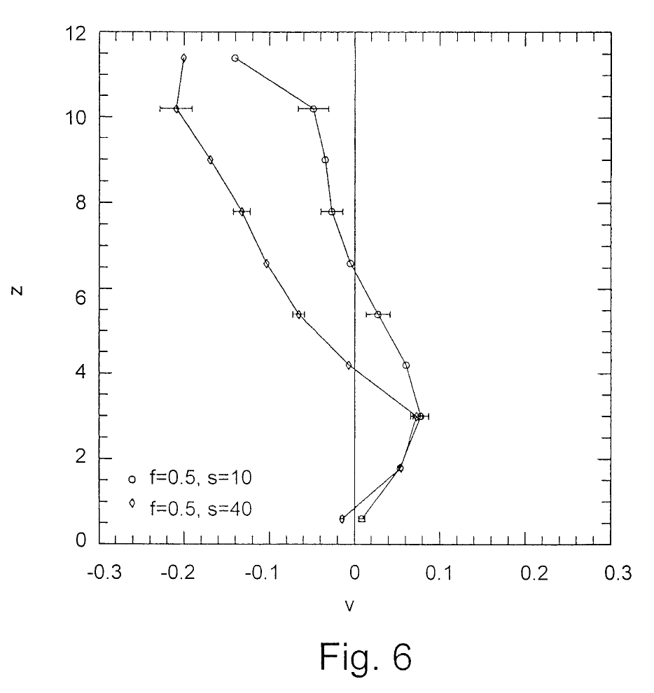

In FIG. 6 is shown the height (z) dependence of the stratified flow velocity for 12 layers. A typical velocity profile starts with negative or near-zero flow at the bottom level; the flow initially increases with z, reaches a positive maximum, and then starts to drop, in most cases becoming negative again. The curves for s=10 (wide teeth) and s=40 (narrow teeth) are the most negative at the upper levels, while intermediate curves show strong positive maxima near z=3.

The preferred flow directions at different levels reflect the key features of the system. The behavior of the grains near the base is reminiscent of a thin layer that can flow in either direction, depending on the prevailing conditions. On the other hand, the asymmetry of the sawteeth used here, which in themselves would be more likely to reflect a single falling grain in the negative direction, indirectly influences the behavior in the upper levels. This effect is transmitted through the intervening material which could well be moving in the opposite direction. When there is positive flow at the lower levels the competition between these opposing effects produces the counterflowing velocity profiles.

An alternate geometry, describing a 3-D system with cylindrical symmetry, will now be considered briefly.

The base consists of a set of concentric circular grooves, shaped to give a radial profile identical to the two-dimensional case. Given the substantially greater number of particles necessary to achieve a linear size similar to that of the two-dimensional system, only a limited exploration of this system has been undertaken.

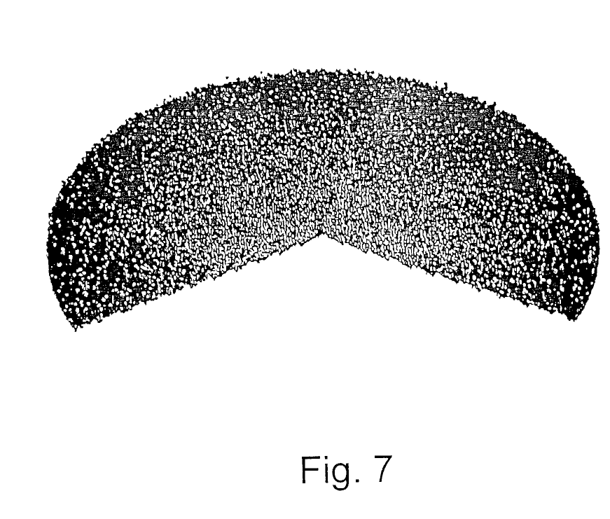

A computer screen image showing a late stage in the segregation (after 2000 vibration cycles) is shown in FIG. 7. The system in this case is a cylindrical container of diameter 180, nominal layer thickness 8, and containing 11 concentric sawtooth grooves. The large particle size is 1.5 and fraction is 0.33. The sawtooth profile is oriented so that large particles should migrate towards the outer boundary of the cylindrical container. In FIG. 7, a wedge shaped region has been removed from the front (the container itself is not shown) to reveal both the upper surface and a vertical cross-section. The larger particles are more darkly shaded and are concentrated at the outer boundary as expected.

In summary, under certain conditions, the upper and lower layers of the material are able to move horizontally in opposite directions due to the influence of the sawtooth-shaped base. At the same time, the same vibrations cause the larger particles to climb towards the top of the layer. It is thus apparent that some degree of horizontal segregation of large and small particles will occur as a consequence, and the simulations reveal the high degree of effectiveness of the process.

Although embodiments of the invention has been described by way of illustration, it will be understood that the invention may be carried out with many variations, modifications, and adaptations, without departing from its spirit or exceeding the scope of the claims.

1. Method for separating granules of different sizes from a granular mixture, by combination of vertical size separation under vibration and horizontal flow.

2. Method according to claim 1, which comprises the steps of:
a) providing a horizontal base plate with an asymmetric sawtooth upper profile;
b) feeding a mixture of granules onto said base plate;
c) vertically vibrating said base plate, whereby to separate the mixture into superimposed, partial layers of granules of different sizes, while horizontally advancing the same in opposite directions; and
d) separately collecting the said layers.

3. Method according to claim 2, for separating two different sizes of granules.

4. Method according to claim 1, wherein a layer of granular particles, consisting of grains of different sizes, is placed on a horizontal base plate and the plate is caused to vibrate in the vertical direction, and whereby two, or more, superimposed partial layers are formed, and the said plate has an asymmetric sawtooth profile, whereby the granular particles flow horizontally in directions perpendicular to the sawteeth.

5. Apparatus for granular separation, which comprises:
e) a base plate having a sawtooth upper profile;
f) a vibrator or vibrators for causing said plate to vibrate vertically;
g) a feeder, or feed mechanism, for feeding the granular mixture to be separated onto said base plate, so as to form a layer thereon; and
h) means for separately collecting the superimposed partial layers of granules produced by the vibration of said base plate.

6. Apparatus according to claim 5, wherein the said feeder is suitably placed above the base plate and feeds the granular mixture at a rate matching the rate at which the granules exit from the apparatus.

7. Apparatus according to claim 5, wherein the means for separately collecting the superimposed layers comprise plates or moving belts and corresponding collecting vessels.

8. Apparatus according to claim 5, comprising means for controlling the vibration amplitude and frequency.

9. Apparatus according to claim 5, having a linear configuration

10. Apparatus according to claim 5, having a circular, elliptical, sloping, or helical (spiral staircase) configuration.

11. Apparatus according to claim 5, having shape and size of sawteeth designed to optimize separation efficiency, likewise for longitudinal and transverse profiles of the base.

12. Apparatus according to claim 5, wherein fluidization of granular layers may be enhanced by vertical flow of injected gas.

13. Apparatus according to claim 5, wherein the sawtooth base is just one component in a multi-stage separation.

14. Method for separating granules of different sizes from a granular mixture, substantially as described and illustrated.

15. Apparatus for granular separation, substantially as described and illustrated.
